(19) United States
(12) Patent Application Publication
(10) Pub. No.: US 2015/0194046 A1
(43) Pub. Date: Jul. 9, 2015

(54) METHODS AND SYSTEMS FOR DETERMINING COMPROMISED HIGH SPEED DATA CHANNELS

(71) Applicant: THE CHARLES STARK DRAPER LABORATORY, INC., Cambridge, MA (US)

(72) Inventors: Robert Tingley, Cambridge, MA (US); Elliot Ranger, Cambridge, MA (US); John Merullo, Cambridge, MA (US)

(73) Assignee: THE CHARLES STARK DRAPER LABORATORY, INC., Cambridge, MA (US)

(21) Appl. No.: 14/177,743

(22) Filed: Feb. 11, 2014

Related U.S. Application Data
(60) Provisional application No. 61/763,337, filed on Feb. 11, 2013.

(51) Int. Cl. G08B 29/04; H04L 25/03

(52) U.S. Cl. CPC G08B 29/046; H04L 25/03006; H04L 25/03343; H04L 2025/0349

(57) ABSTRACT

An Integrated Circuit (IC) determines tampering of a communication channel between one or more components by determining, via a channel equalizer coupled to the communication channel, filter coefficients of the communication channel. The IC further compares, via a comparator, the filter coefficients to a tamper threshold and indicates tampering of the data channel when the tamper threshold is exceeded. The tamper threshold is determined by the channel equalizer based, in part, on initial filter coefficients.

### CROSS-REFERENCE TO RELATED APPLICATIONS

The present application is claiming priority of U.S. Provisional Patent Application Ser. No. 61/763,337, filed on Feb. 11, 2013, the content of which is herein incorporated by reference.

### TECHNICAL FIELD

The present disclosure relates generally to monitoring high speed data channels, and, more particularly, to determining whether a high speed data channel is compromised.

### BACKGROUND

Integrated circuit scaling and shifts in computer architectures from single-core to multi-core systems improved processing power and resulted in an increase of on-chip aggregate bandwidths for communicating data (e.g., between chips). In particular, data is transmitted between chips via high-speed data signaling on various communication channels. However, such communication channels are known areas of weakness. That is, such channels can be compromised (e.g., disrupted, tampered, etc.) and even monitored by unwanted third parties. Various techniques have been employed in an attempt to mitigate this data channel weakness; however, such techniques typically require overly complex designs, additional hardware, etc., which ultimately require additional resources that can impact cost, performance and scalability.

### SUMMARY

High speed data signaling employ specialized circuitry, including high speed channel equalizers and specially controlled-impedance channels to achieve high bandwidth data rates. Channel equalizers compensate for various disturbances (e.g., environmental effects, temperature, ionizing radiation, electrical interference, etc.) that alter an impedance of the data channel and adjust filter coefficients to ensure data is properly exchanged amongst integrated circuits.

According to one or more embodiments disclosed herein, techniques for determining compromised high speed data channels include determining filter coefficients of a channel equalizer (e.g., tapping filter registers) associated with a data channel, comparing the filter coefficients (e.g., via a comparator) to a tamper threshold, and indicating tampering of the data channel when the tamper threshold is exceeded. In further embodiments, these techniques include steps for altering data signals exchanged between an Integrated Circuit (IC) and the data channel in response to an indicated tampering.

Also disclosed herein is are techniques for generating a waveform from a waveform generator, transmitting the waveform on a communication channel, receiving in response to the transmitted waveform, a modified waveform, determining, via a tamper monitor, if the modified waveform exceeds a threshold condition, and indicating that the communication channel is compromised when the threshold condition is exceeded.

In one or more additional embodiments, techniques are disclosed for indicating tampering with a high speed communication channel between two components. These techniques include steps of performing a training sequence of communication between the two components across the high speed communication channel to determine initial filter coefficients of a channel equalizer coupled to the high speed communication channel, acquiring subsequent filter coefficients of the high speed communication channel periodically during use, determining differential filter coefficient values based upon the initial and subsequent filter coefficients, and providing a tamper evident signal when the differential filter coefficient values exceed a threshold.

It should be appreciated that the present technology can be implemented and utilized in numerous ways, including without limitation as a process, an apparatus, a system, a device, a method for applications now known and later developed. These and other unique features of the technology disclosed herein will become more readily apparent from the following description and the accompanying drawings.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 is a schematic block diagram of an exemplary electronic system according to the present disclosure;

FIG. 2 is a schematic block diagram of another exemplary electronic system according to the present disclosure; and

FIG. 3 is an example simplified procedure for determining compromised high speed data channels.

### DETAILED DESCRIPTION

Various techniques have been employed in an attempt to mitigate tampering and monitoring of data channels by unwanted parties. Such techniques typically require overly complex designs. However, the novel approaches disclosed herein provide simple, but efficient protection against unwanted tampering and/or monitoring of data channels. Some of the techniques as described herein monitor high speed channel equalizers to determine when physical or environmental changes (e.g., tampering or third party monitoring) occur in data channels. Such techniques can provide for monitoring and analyzing coefficients of high speed channel equalizers, which coefficients reflect a status of a corresponding channel. Further techniques provide for monitoring waveforms via a tamper monitor to determine if a data channel is compromised. For example, these techniques can analyze modified waveforms (e.g., waveforms modified by a corresponding data channel), determine if the modified waveform exceeds a threshold condition, and indicate that the data channel is compromised when exceeded.

High speed data signaling employs specialized circuitry, including high speed channel equalizers as well as carefully designed controlled-impedance channels to achieve high data rates. Channel distortion such as frequency-dependent loss and impedance discontinuities are known limiters in data rate scaling. Channel equalizers are employed to cancel interference caused by channel distortion and can include, for example, linear filters (both discrete and continuous-time) that flatten channel frequency responses, or non-linear filters that directly cancel intersymbol interference (ISI) based on a received data sequence. Different combinations of equalization can employed depending on system data rate requirements relative to channel bandwidth and the severity of potential noise sources.

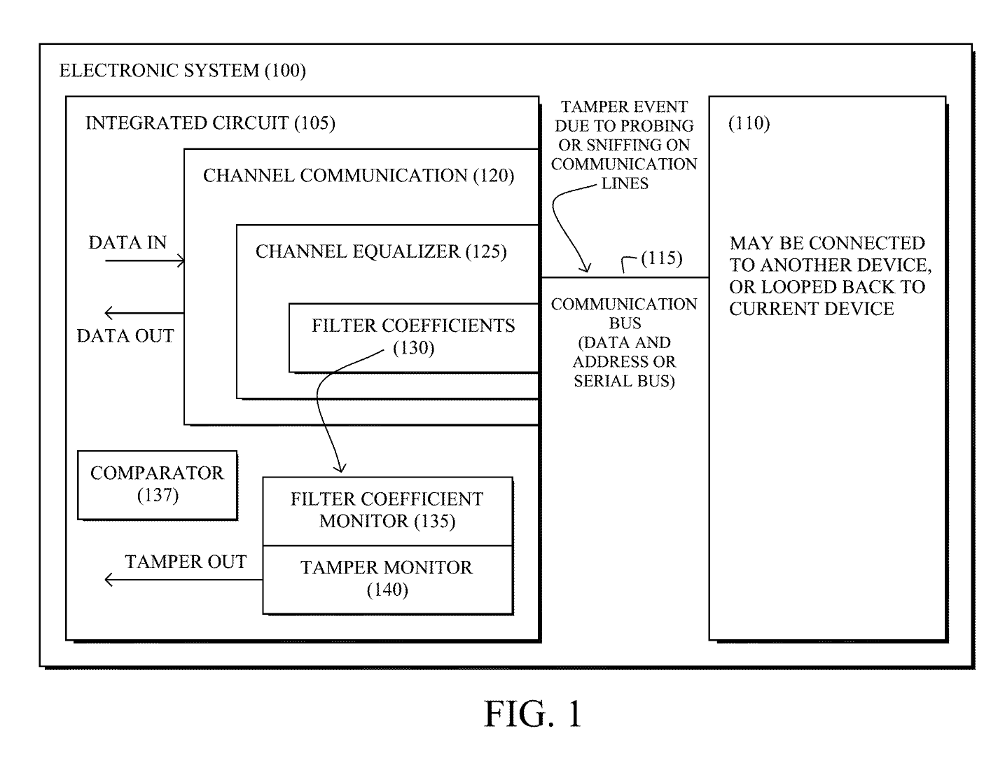

FIG. 1 illustrates a schematic block diagram of an exemplary electronic system (i.e., system 100) according to the present disclosure. System 100 includes an integrated circuit (IC) 105 that exchanges or communicates data via channel communication circuitry 120 (e.g., the mechanical, electrical, signaling, transmitting, and receiving circuitry for communicating data). In operation, IC 105, via channel communication circuitry 120, can communicate with itself (e.g., data is looped back into IC 105) as well as communicate with one or more additional devices or components such as other ICs 110 via one or more channel(s) 115. Notably, channel communication circuitry 120 can include a transmitter and a receiver (not shown). Communication channel 115 include wired links (e.g., one or many serial connections, one or many parallel communications, optical links, and/or non-wired links, etc.). Additionally, those skilled in the art will understand that while system 100 is shown in a certain orientation, system 100 is merely an example illustration that is not meant to limit this disclosure.

As discussed above, channel 115 can be subject to various disturbances (e.g., environmental effects, temperature, ionizing radiation, electrical interference, etc.), which can alter its impedance. Channel equalizer 125 compensates for these disturbances by applying one or more filters having filter coefficients 130 and equalizes data signals on channel 115 thereby ensuring that data is properly exchanged amongst ICs 105 and 110. Put differently, when disturbances in channel 115 occur, channel equalizer 125 adjusts filter coefficients 130 to tune channel 115. Filter coefficients 130 include, for example, tap weights such as the values for aₘ in a tapped delay line (i.e., transversal filter) adaptive implementation of the channel equalizer 125:

$$y ( n ) = {\sum }_{m = 0}^{N - 1} {a}_{m} x ( n - m )$$

where: y is the output of the filters, x is the input, and N is the sample size. In the case of finite impulse response (“FIR”) filters the set of aₘ values are sometimes referred to as a “coefficient stack.” Other filters can also be used, as is understood by those skilled in the art (e.g., i.e. linear filter, adaptive filter, viterbi filter, etc.)

Notably, in some embodiments, IC 105 can perform an equalizer check via training sequences that can place specified data signals on channel 115. A purpose of the equalizer check is to obtain prior information on signal and noise statistics. For example, a training sequence can be used to determine a non-tampered state of channel 115. Coefficients in the equalizer can be updated by re-running the training sequence or by monitoring the communication on channel 115 and updating the filter coefficients based on signal noise, etc. The equalizer check can be performed at various times (e.g., prior to data signaling, interspersed between data signaling, at regular intervals, etc.). These statistics can be used in the design of a fixed filter implementation of the channel equalizer 125, such as one based on a discrete Wiener filter.

In the event that someone tampers with the channel 115 (e.g., monitors the channel, interferes with the data signals, probes the contents of the data signals, etc.), a disturbance is created. In turn, equalizer 125 compensates for the disturbance and adjusts filter coefficients 130. The techniques disclosed herein can compare, by comparator 137, initial filter coefficients with subsequent filter coefficients to yield differential coefficients and also indicate tampering of the data channel if the differential coefficients exceed a threshold. That is, filter coefficients 130 associated with tuning channel 115 can be monitored by a filter coefficient monitor 135. Filter coefficient monitor 135 can determine changes to channel 115. For example, filter coefficient monitor 135 can examine registers of channel equalizer 125 (e.g., registers that include filter coefficients 130). Filter coefficient monitor 135 can further include a tamper monitor 140 that can discriminate between normal disturbances to channel 115 versus tampering disturbances consistent with someone probing channel 115. Once a tamper condition is determined, tamper monitor 140 can output a tamper signal indicating that the channel is compromised. Notably, the various components shown in FIG. 1 may be included and/or operatively coupled to other components as is appreciated by those skilled in the art (e.g., comparator 137 may be part of tamper monitor 140, etc.)—such components are shown for illustrative purposes and are not meant to limit this disclosure.

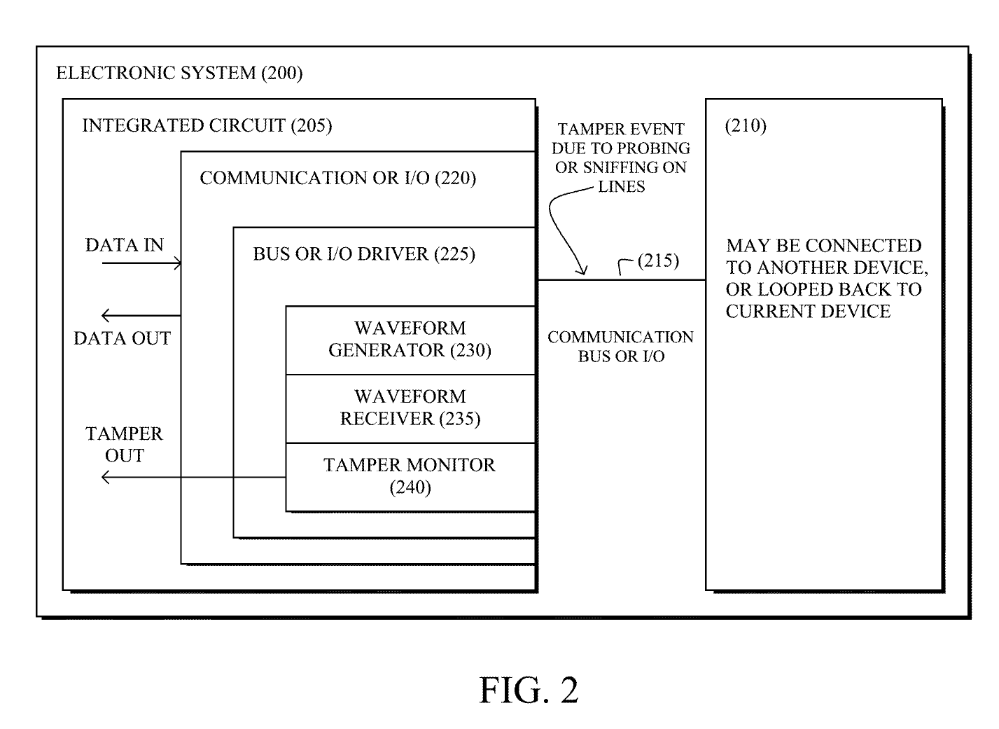

FIG. 2 illustrates another exemplary electronic system (i.e., system 200) according to the present disclosure. System 200 includes an IC 105 and an IC 210. IC 105 can exchange or communicate data via communication circuitry 220 (e.g., the mechanical, electrical, and signaling circuitry for communicating data). Similar to IC 105, IC 205 can communicate with itself (e.g., data is looped back into IC 205) as well as communicate with one or more additional ICs via one or more channel(s) 215. Channel 215 can include wired links (e.g., one or many serial connections, one or many parallel communications, optical links, etc.). Additionally, those skilled in the art will understand that while system 200 is shown in a certain orientation, system 200 is merely an example illustration that is not meant to limit this disclosure.

Communication circuitry 220 can include a bus or I/O driver 225. Bus or I/O driver 225 can include software/hardware that controls hardware interfaces such as a waveform generator 230, a waveform receiver 235 and a tamper monitor 240. Communication circuitry 220 can further exchange data on a channel 215 with IC 210.

Operatively, waveform generator 230 can generate a waveform that can be sent over channel 215 to IC 210. Waveform receiver 235 can receive a modified waveform, which is typically a combination (e.g., superposition in the case of a linear system) of the original waveform that generator 230 sends and a waveform that exhibits the effects of being propagated over channel 215 (i.e., the modified waveform). The waveform sent from IC 210 back to waveform receiver 235 could be, for example, a reflection (based on the impedance of IC 210), or a signal retransmitted by one or more buffers and/or line receivers-drivers in IC 210. For example, for simplex channels, IC 205 can transmit data while IC 210 receives (e.g., “listens”) and vice versa. IC 210 can include similar hardware as IC 205 and include waveform receiver that receives the transmitted data from waveform generator 230.

As discussed above with respect to system 100, an equalizer check (e.g., a training sequence) can be implemented prior to communication on channel 215 or with some regularity to ensure that disturbances have not resulted in modifications to the channel. Tampering or disturbing the channel directly changes/modifies the received waveform at waveform receiver 235. A tamper monitor 240 can monitor received waveforms at waveform receiver 235 and compare such waveforms to a threshold (e.g., an initial control waveform). Tamper monitor 240 discriminates between ‘normal’ disturbances of waveforms versus disturbances that are consistent with someone probing channel 215. Tamper monitor 240 can output a tamper signal if the received waveform exceeds the threshold to indicate the channel is compromised (e.g., someone is probing on the channel).

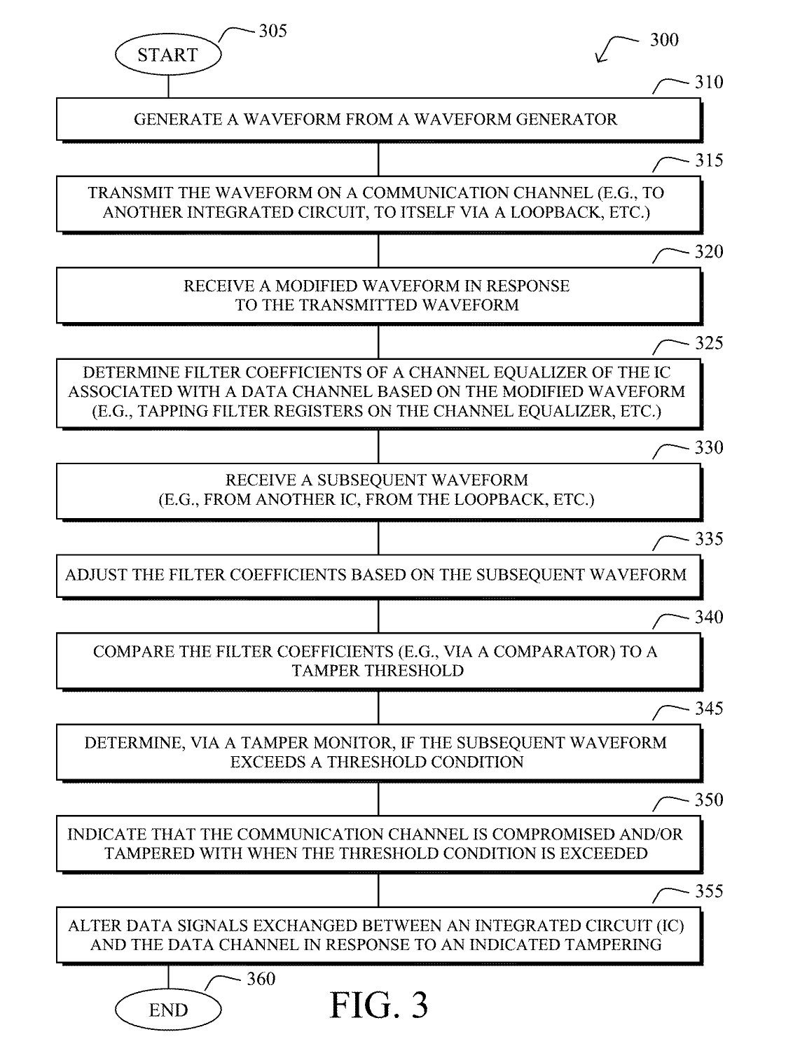

FIG. 3 is an example simplified procedure 300 for determining compromised high speed data channels, particularly from the perspective of an integrated circuit (IC).

Procedure 300 begins at 305 and proceeds to step 310 where, as described above, the IC generates a waveform from a waveform generator. The IC transmits the waveform on a communication channel (e.g., to another IC, to itself via a loopback channel, etc.) at 315. Next, at 320, the IC receives a modified waveform in response to the transmitted waveform (e.g., due to channel impendences and the like). As discussed above, the IC can transmit certain baseline sequences to establish baseline filter coefficients of a channel equalizer for the corresponding communication channel. The IC determines, at 325, these baseline filter coefficients of the corresponding communication channel equalizer based on the modified waveform—for example, filter registers on the channel equalizer can be tapped to determine these filter coefficients. Next, at 330, the IC receives a subsequent waveform (e.g., from another IC, from the loopback, etc.) and at 335, the IC adjusts its filter coefficients based on the subsequent waveform. The filter coefficients are then compared, at 340 (e.g., via a comparator of the IC, etc.) to a tamper threshold. When the subsequent waveform exceeds the tamper threshold (at 345), the IC, at indicates at 350 the data the communication channel is compromised and/or indicates tampering. Optionally, the IC (at 355) can further alter data signals exchanged from the IC and on data channel in response to the data channel being compromised and/or improperly tampered with.

The techniques described herein provide for determining compromised data channels between various integrated circuits (ICs). In particular, high speed channels, the techniques provide for monitoring an equalizer (e.g., filter coefficients) and/or a waveform receiver (e.g., received waveforms). The monitored signals can be compared against a threshold condition, which when exceeded can be used to indicate the underlying channel is compromised.

It should be noted that while certain steps within procedure 300 may be optional as described above, the steps shown in FIG. 3 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

While there have been shown and described illustrative embodiments that provide for monitoring high speed channels, it is to be understood that various other adaptations and modifications may be made within the spirit and scope of the embodiments herein. For example, the embodiments have been shown and described herein with relation to high speed communication channels. However, the embodiments in their broader sense are not as limited, and may, in fact, be used with other types of channels where appropriate. In addition, while the above techniques have generally been described in terms of modules resident in particular parts of an IC, such modules can be employed as independent devices and/or incorporated in other portions (or other modules) of the IC.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method for determining tampering of a communication channel between one or more components, the method comprising:
determining, via a channel equalizer coupled to the communication channel, filter coefficients of the communication channel;
comparing, via a comparator in communication with the channel equalizer, the filter coefficients to a tamper threshold; and
indicating, via the comparator, tampering of the data channel when the tamper threshold is exceeded, wherein the tamper threshold is determined by the channel equalizer based, in part, on initial filter coefficients.

2. The method of claim 1, wherein determining, via the channel equalizer, filter coefficients comprises tapping filter registers on the channel equalizer.

3. The method of claim 1, wherein the channel equalizer and the comparator are further coupled to an Integrated Circuit that transmits data on the communication channel, the method further comprising:
altering data signals transmitted by the IC to the communication channel in response to an indicated tampering.

4. An apparatus for determining tampering of a communication channel between one or more components, the apparatus comprising:
a waveform generator that transmits a waveform to the communication channel;
a receiver that receives a modified waveform responsive to the transmitted waveform;
a channel equalizer that adjusts filter coefficients based on the received modified waveform; and
a tamper monitor that monitors the filter coefficients of a channel equalizer of the communication channel and indicates the communication channel is compromised when the filter coefficients exceed a threshold.

5. The apparatus of claim 4, further comprising:
a comparator coupled to the tamper monitor, wherein the tamper monitor determines when the filter coefficients exceed the threshold by the comparator.

6. The apparatus of claim 4, further comprising:
filter taps operatively coupled to the channel equalizer and the tamper monitor, wherein the tamper monitor monitors the filter coefficients by the filter taps.

7. An apparatus for determining tampering of a communication channel between one or more components, the apparatus comprising:
a channel equalizer associated with the communication channel, the channel equalizer having one or more filter coefficient registers;
a filter coefficient monitor that determines filter coefficients from the filter coefficient register; and
a tamper monitor that compares the filter coefficients to a threshold and indicates the communication channel is compromised when exceeded.

8. The apparatus so of claim 7, further comprising:
a waveform generator that transmits an initial waveform to the communication channel;
a receiver that receives a modified waveform from the communication channel responsive to the initial waveform, wherein the channel equalizer adjusts the one or more filter coefficient registers based on the modified waveform, and
wherein the tamper monitor determines the threshold based on the adjusted filter coefficient registers based on the modified waveform.

9. The apparatus so of claim 7, wherein the tamper monitor indicates the communication channel is compromised by a tamper signal.
